(19) United States
(12) Patent Application Publication
(10) Pub. No.: US 2004/0203578 A1
(43) Pub. Date: Oct. 14, 2004

(54) Method and communication network for rewarding subscribers based on usage of air time

(76) Inventor: Ichiro Toriyama, San Diego, CA (US)

Correspondence Address: Anthony G. Sitko, MARSHALL, GERSTEIN & BORUM, 6300 Sears Tower, 233 South Wacker Drive, Chicago, IL, 60606-6357, US

(21) Appl. No.: 10/287,260

(22) Filed: Nov. 4, 2002

(51) Int. Cl. H04M 11/00; H04M 3/42

(52) U.S. Cl. 455/405; 455/414.1

(57) ABSTRACT

A method (300) and a communication network (110) for rewarding subscribers based on usage of air time are described herein. The communication network (110) may determine usage of air time for communication services by a subscriber (A1). Based on the usage of air time, the communication network (110) may assign a number of points to the subscriber (A1). Accordingly, the communication network (110) may store the number of points assigned to the subscriber in a point account (222) associated with the subscriber (A1). The points accrued in the point account (222) may be redeemed by the subscriber (A1) for one of a service and a product.

### TECHNICAL FIELD

The present disclosure relates to wireless communication systems, and more particularly, to a method and a communication network for rewarding subscribers based on usage of air time.

### BACKGROUND

In many industries today, companies are offering incentive programs to entice customers into purchasing or using services and/or products by those companies. Typically, customers receive points for purchases to receive a service or a product that is unavailable or at a higher cost to those without the points. For example, the airline industry offers free travel and/or upgrades to customers based on mileage. That is, customers may earn mileage by traveling or purchasing airline tickets to redeem for services and/or products. In fact, many industries work in conjunction with one another to offer incentive programs to customers for making every day purchases such as meals and groceries. For example, a credit card company awards points to customers who use its credit card to make those purchases. Accordingly, those customers can redeem the points accrued by using the credit card for mileage with an airline or upgrade with a hotel. Further, some companies implement incentive programs to promote a service and/or a product. For example, customers may earn additional points for online reservations, i.e., purchasing airline tickets or booking hotel rooms via the Internet.

As technology advances, more and more services and products are available to the public. In particular, people can select from a wide variety of providers, services, and products for wireless communication services. Because of the competitive nature of the business, however, potential subscribers may be enticed to select a particular provider, service, or product. Therefore, a need exists to provide an incentive for subscribers of wireless communication services to use a particular provider, service or product.

### BRIEF DESCRIPTION OF THE DRAWINGS

This disclosure will describe several embodiments to illustrate its broad teachings. Reference is also made to the attached drawings.

FIG. 1 is a block diagram representation of a wireless communication system.

FIG. 2 is a block diagram representation of a communication network.

FIG. 3 is a flow diagram illustrating a method for rewarding subscribers based on air time usage.

### DETAILED DESCRIPTION

A method and a communication network for rewarding subscribers based on usage of air time are described. In particular, the communication network may determine usage of air time for communication services by a subscriber. For example, the communication network may monitor usage of air time (e.g., minutes and seconds) for communication services such as, but not limited to, voice call service, conference call service, e-mail service, short messaging service (SMS), multimedia messaging service (MMS), instant messaging service, or wireless application protocol (WAP) service by a subscriber. To promote a product from a particular manufacturer (e.g., Motorola), the communication network may also monitor usage of air time for communication services by the subscriber via a user equipment such as, but not limited to, one of a cellular telephone, a pager, a personal digital assistant (PDA), a portable computer, and a laptop computer. Alternatively, the communication network may retrieve usage of air time from a database associated with a communication service provider, which keeps track of air time of the subscriber for billing purposes.

Based on the usage of air time, the communication network may assign a number of points to the subscriber. The communication network may generate a point account corresponding to the subscriber within a database, and store the number of points assigned to the subscriber in the point account. Accordingly, the subscriber may accrue points in the point account based on the usage of air time and then withdraw the accrued points to redeem for either a service or a product. For example, the subscriber may redeem for additional air time, software and applications (e.g., ring tones, games, and graphics), features (e.g., caller identification, three-way calling, call forwarding, call waiting, international dialing and voicemail), and/or accessories (e.g., headsets, speakers, batteries, battery chargers, vehicle adapters, cases, holsters, and covers). As a result, the subscribers may be enticed to use a particular provider, service or product by the incentives.

A communication system in accordance with the present disclosure is described in terms of several preferred embodiments, and particularly, in terms of a wireless communication system operating in accordance with at least one of several standards. These standards include analog, digital or dual-mode communication system protocols such as, but not limited to, the Advanced Mobile Phone System (AMPS), the Narrowband Advanced Mobile Phone System (NAMPS), the Global System for Mobile Communications (GSM), the IS-55 Time Division Multiple Access (TDMA) digital cellular system, the IS-95 Code Division Multiple Access (CDMA) digital cellular system, the CDMA 2000 system, the Wideband CDMA (W-CDMA) system, the Personal Communications System (PCS), the Third Generation (3G) system, the Universal Mobile Telecommunications System (UMTS) and variations and evolutions of these protocols.

A wireless communication system is a complex network of systems and elements. Typical systems and elements include (1) a radio link to mobile stations (e.g., a cellular telephone or a subscriber equipment used to access the wireless communication system), which is usually provided by at least one and typically several base stations, (2) communication links between the base stations, (3) a controller, typically one or more base station controllers or centralized base station controllers (BSC/CBSC), to control communication between and to manage the operation and interaction of the base stations, (4) a switching system, typically including a mobile switching center (MSC), to perform call processing within the system, and (5) a link to the land line, i.e., the public switch telephone network (PSTN) or the integrated services digital network (ISDN).

A base station subsystem (BSS) or a radio access network (RAN), which typically includes one or more base station controllers and a plurality of base stations, provides all of the radio-related functions. The base station controller provides all the control functions and physical links between the switching system and the base stations. The base station controller is also a high-capacity switch that provides functions such as handover, cell configuration, and control of radio frequency (RF) power levels in the base stations.

The base station handles the radio interface to the mobile station. The base station includes the radio equipment (transceivers, antennas, amplifiers, etc.) needed to service each communication cell in the system. A group of base stations is controlled by a base station controller. Thus, the base station controller operates in conjunction with the base station as part of the base station subsystem to provide the mobile station with real-time voice, data, and multimedia services (e.g., a call).

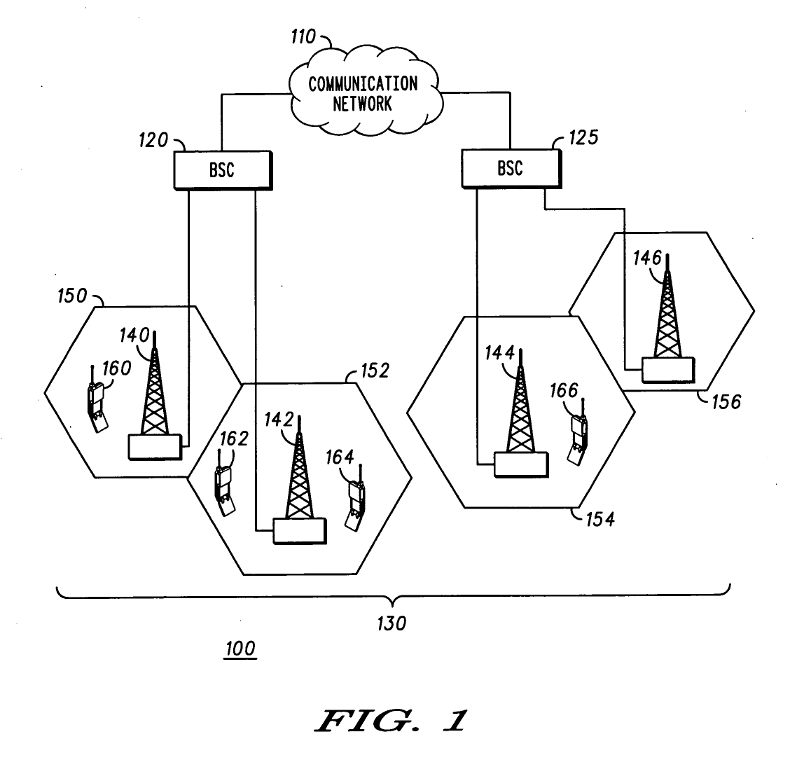

Referring to FIG. 1, a wireless communication system 100 includes a communication network 110, and a plurality of base station controllers (BSC), generally shown as 120 and 125, servicing a total service area 130. As is known for such systems, each BSC 120 and 125 has associated therewith a plurality of base stations (BS), generally shown as 140, 142, 144, and 146, servicing communication cells, generally shown as 150, 152, 154, and 156, within the total service area 130. The BSCs 120 and 125, and base stations 140, 142, 144, and 146 are specified and operate in accordance with the applicable standard or standards for providing wireless communication services to mobile stations (MS) (i.e., user equipment), generally shown as 160, 162, 164, and 166, operating in communication cells 150, 152, 154, and 156, and each of these elements are commercially available from Motorola, Inc. of Schaumburg, Ill.

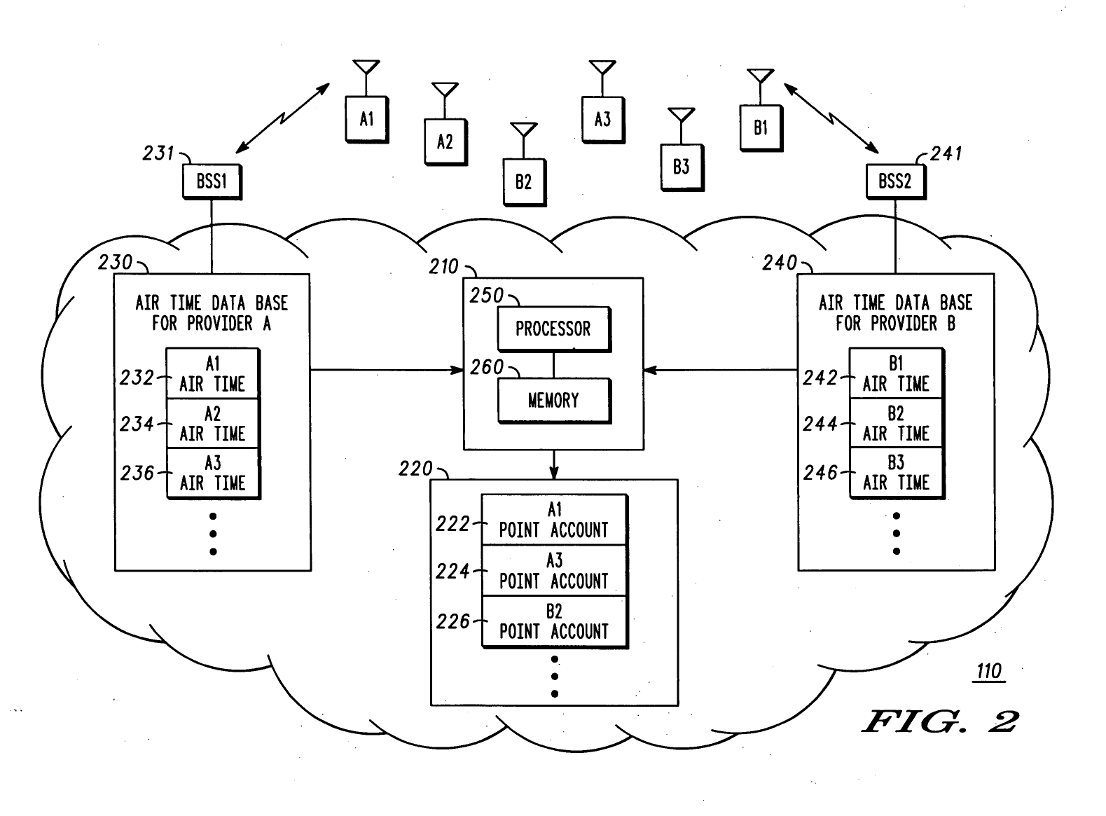

Referring to FIG. 2, the communication network 110 adapted to reward subscribers based on usage of air time is shown. The communication network 110 generally includes a controller 210, and a point account database 220. The controller 210 may be operatively coupled to a first air time database 230 and a second air time database 240, which are described in further detail below. In particular, the controller 210 includes a processor 250 and a memory 260. The processor 250 is operatively coupled to the memory 260, which stores a program or a set of operating instructions for the processor 250. The processor 250 executes the program or the set of operating instructions such that the communication network 110 operates as described herein. The program of the set of operating instructions may be embodied in a computer-readable medium such as, but not limited to, paper, a programmable gate array, an application specific integrated circuit (ASIC), an erasable programmable read only memory (EPROM), a read only memory (ROM), a random access memory (RAM), a magnetic media, and an optical media.

A basic flow for rewarding subscribers based on usage of air time may start with the communication network 110 offering wireless communication services to a plurality of subscribers, generally shown as A1, A2, A3, B1, B2, and B3. In particular, a first communication service provider (i.e., Provider A) may provide communication services to Subscribers A1, A2, and A3 via a first base station subsystem 231 (BSS1), and a second communication service provider (i.e., Provider B) may provider communication services to Subscribers B1, B2, and B3 via a second base station subsystem 241 (BSS2). Each of Provider A and Provider B keeps track of the air time (e.g., minutes and seconds) used by its respective subscribers. In particular, the first air time database 230 includes accounts (shown as 232, 234, and 236) of air time used by Subscribers A1, A2, and A3, respectively. In a similar manner, the second air time database 240 includes accounts (shown as 242, 244, and 246) of air time used by Subscribers B 1, B2, and B3.

The communication network 110 may generate a point account, generally shown as 222, 224, and 226, within the point database 220 for each of the subscribers participating in an air time usage program (i.e., a subscriber may earn points based on air time used for communication services). Although the first and second air time databases 230, 240 are associated with different communication service providers (i.e., Provider A and Provider B, respectively), the point database 220 may include point accounts associated with subscribers of different communication service providers. For example, the point database 220 may include point accounts 222, 224 for Subscribers A1 and A3 of Provider A, respectively, and a point account for Subscriber B2 of Provider B.

Subscribers may earn points by using a particular provider, service or product. In particular, the communication network 110 may retrieve usage of air time from the air time accounts stored in the air time databases 230, 240. For example, the communication network 110 may retrieve the number of minutes and/or seconds used by Subscriber B3 for the wireless communication services from the second air time database 240 (i.e., the content of the air time account 246). Alternatively, the communication network 110 may monitor usage of air time by subscribers for communication services. That is, the air time databases 230, 240 may not be necessary because the controller 210 may monitor usage of air time and store the corresponding values within the point database 220.

Based on the usage of air time for wireless communication services, the communication network 110 may assign points to subscribers. For example, a subscriber may be assigned with a number of points for initiating a voice call. The number of points may be based on the amount of air time used for the voice call (i.e., the duration of the voice call). The communication network 110 may assign points for other services such as, but not limited to, conference call service, e-mail service, short messaging service (SMS), multimedia messaging service (MMS), instant messaging service, or wireless application protocol (WAP) service. Following the example described above, the communication network 110 may assign additional points (e.g., bonus points) to the subscriber for initiating the voice call via a particular brand of user equipment (e.g., the Motorola v.60i cellular telephone) or a particular communication service provider (e.g., a subscriber plan offered by Provider A). Further, the communication network 110 may assign more points for using a particular type of user equipment (e.g., a cellular telephone, a pager, a personal digital assistant (PDA), a portable computer, and a laptop computer). To promote portable computers, for example, a subscriber may earn more points for the usage of air time via a portable computer than a subscriber who uses a pager. Thus, subscribers may earn more points based on the particular provider, service or product associated with the usage of air time.

Accordingly, the communication network 110 may store points assigned to the subscribers in the point accounts within the point database 220. As more and more points are accrued within the point accounts, the subscribers may redeem those points for additional air time, software and applications (e.g., ring tones, games, and graphics), features (e.g., caller identification, three-way calling, call forwarding, call waiting, international dialing and voicemail), and/or accessories (e.g., headsets, speakers, batteries, battery chargers, vehicle adapters, cases, holsters, and covers). Thus, subscribers may be rewarded for using a particular provider, service or product.

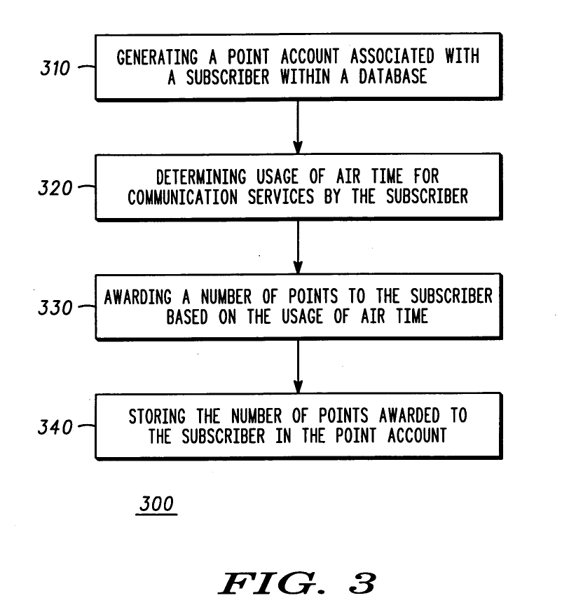

One possible implementation of the computer program executed by the communication network 110 (e.g., via the processor 250) is illustrated in FIG. 3. Persons of ordinary skill in the art will appreciate that the computer program can be implemented in any of many different ways utilizing any of many different programming codes stored on any of many computer-readable mediums such as a volatile or nonvolatile memory or other mass storage device (e.g., a floppy disk, a compact disc (CD), and a digital versatile disc (DVD)). Thus, although a particular order of steps is illustrated in FIG. 3, persons of ordinary skill in the art will appreciate that these steps can be performed in other temporal sequences. Again, the flow chart 300 is merely provided as an example of one way to program the controller 210 to reward subscribers based on air time usage. The flow chart 300 begins at step 310, wherein the controller 210 may generate at least one point account within the point account database 220. Each of the point accounts corresponds to a subscriber. At step 320, the controller 210 may determine usage of air time for communication services by the subscriber. For example, the controller 210 may monitor the number of minutes used for communication services such as voice call service, conference call service, e-mail service, short messaging service (SMS), multimedia messaging service (MMS), instant messaging service, and wireless application protocol (WAP) service. Alternatively, the controller 210 may retrieve the usage of air time by the subscriber from the communication service provider of the communication services. For example, the controller 210 may retrieve the usage of air time by Subscriber A1 from the first provider database 230 (i.e., the content of air time account 232). Based on the usage of air time, the controller 210 at step 330 may assign a number of points to the subscriber. The controller 210 may also consider the type of product, the type of service, and the communication service provider associated with the usage of air time when assigning points to the subscriber. To promote certain services such as IM service or SMS, for example, those services may correspond to more points as oppose to other services such as voice call service. In another example, Provider A may offer more points than Provider B for each minute used in a subscriber plan offered by Provider A. Upon assigning the numbers of points, the controller 210 at step 340 may store the number of points in the point account corresponding to the subscriber within the point account database 220. Following the above example, the controller 210 may store the number of points assigned to Subscriber A1 in the point account corresponding to Subscriber A1. As more and more points are accrued in the point account for usage of air time, the subscriber may redeem for either a service or a product. For example, Subscriber A1 may redeem points from point account 222 for additional air time, software and applications, features, and/or accessories. Thus, subscribers may be rewarded for using a particular provider, service or product.

Although the embodiments disclosed herein are particularly well suited for use with communication service providers, persons of ordinary skill in the art will readily appreciate that the teachings of this disclosure can be employed with communication equipment manufacturers. For example, a cellular telephone manufacturer may provide accessories as mentioned above to the cellular telephone based on usage of air time. In another example, the manufacturer may upgrade the subscriber to a new cellular telephone based on usage of air time.

Many changes and modifications to the embodiments described herein could be made. The scope of some changes is discussed above. The scope of others will become apparent from the appended claims.

1. A method in a wireless communication system providing communication services to subscribers, the method comprising:
determining usage of air time for communication services by a subscriber;
assigning a number of points to the subscriber based on the usage of air time; and
storing the number of points assigned to the subscriber in a point account associated with the subscriber.

2. The method of claim 1, wherein the step of determining usage of air time for communication services by a subscriber comprises monitoring usage of air time for communication services by the subscriber.

3. The method of claim 1, wherein the step of determining usage of air time for communication services by a subscriber comprises retrieving usage of air time from a database associated with a communication service provider.

4. The method of claim 1, wherein the step of determining usage of air time communication services by a subscriber comprises determining a number of at least one of minutes and seconds associated with communication services.

5. The method of claim 1, wherein the step of determining usage of air time for communication services by a subscriber comprises determining a first usage of air time for a first communication service and a second usage of air time for a second communication service.

6. The method of claim 1, wherein the step of determining usage of air time for communication services by a subscriber comprises determining usage of air time for one of a voice call service, a conference call service, an e-mail service, a short messaging service (SMS), a multimedia messaging service (MMS), an instant messaging service, and a wireless application protocol (WAP) service.

7. The method of claim 1, wherein the step of determining usage of air time for communication services by a subscriber comprises determining usage of air time for communication services by the subscriber via one of a cellular telephone, a pager, a personal digital assistant (PDA), a portable computer, and a laptop computer.

8. The method of claim 1, wherein the step of assigning points to the subscriber based on the usage of air time comprises assigning a first number of points for a first communication service and a second number of points for a second communication service.

9. The method of claim 1, wherein the step of storing the number of points assigned to the subscriber in a point account associated with the subscriber comprises storing the number of points assigned to the subscriber within a database having a plurality of point accounts, one of the plurality of point accounts being associated with the subscriber.

10. The method of claim 1, wherein the communication system comprises one of a code division multiple access (CDMA) based communication system, a time division multiple access (TDMA) based communication system, and a global system for mobile communication (GSM) based communication system.

11. In a wireless communication network providing communication services to subscribers, the communication network comprising:
a database configured to store at least one point account;
a controller operatively coupled to the database, the controller comprising a memory and a processor operatively coupled to the memory,
the controller being programmed to determine usage of air time for communication services by a subscriber;
the controller being programmed to assign a number of points to the subscriber based on the usage of air time; and
the controller being programmed to store the number of points assigned to the subscriber in a point account associated with the subscriber.

12. The communication network of claim 11, wherein the controller is operatively coupled to a database associated with a communication service provider, and the controller is programmed to retrieve usage of air time from the database.

13. The communication network of claim 11, wherein the controller is programmed to monitor usage of air time for communication services by the subscriber.

14. The communication network of claim 11, wherein the controller is programmed to determine a number of at least one of minutes and seconds associated with communication services.

15. The communication network of claim 11, wherein the controller is programmed to determine usage of air time for one of a voice call service, a conference call service, an e-mail service, a short messaging service (SMS), a multimedia messaging service (MMS), an instant messaging service, and a wireless application protocol (WAP) service.

16. The communication network of claim 11, wherein the controller is programmed to determine usage of air time for communication services by the subscriber via one of a cellular telephone, a pager, a personal digital assistant (PDA), a portable computer, and a laptop computer.

17. The communication network of claim 11, wherein the controller is programmed to assign a first number of points for a first communication service and a second number of points for a second communication service.

18. The communication network of claim 11 is operable in accordance with one of a code division multiple access (CDMA) based communication protocol, a time division multiple access (TDMA) based communication protocol, and a global system for mobile communication (GSM) based communication protocol.

19. In a wireless communication network server having a processor that operates in accordance with a computer program embodied on a computer-readable medium for, the computer program comprising:
a first routine that determines usage of air time for communication services by a subscriber;
a second routine that assigns a number of points to the subscriber based on the usage of air time; and
a third routine that stores the number of points assigned to the subscriber in a point account associated with the subscriber.

20. The computer program of claim 19, wherein the first routine comprises a routine that monitors usage of air time for communication services by the subscriber.

21. The computer program of claim 19, wherein the first routine comprises a routine that retrieves usage of air time from a database associated with a communication service provider.

22. The computer program of claim 19, wherein the first routine comprises a routine that determines a number of at least one of minutes and seconds associated with communication services.

23. The computer program of claim 19, wherein the first routine comprises a routine that determines a first usage of air time for a first communication service and a second usage of air time for a second communication service.

24. The computer program of claim 19, wherein the first routine comprises a routine that directs the processor to determine usage of air time for one of a voice call service, a conference call service, an e-mail service, a short messaging service (SMS), a multimedia messaging service (MMS), an instant messaging service, and a wireless application protocol (WAP) service.

25. The computer program of claim 19, wherein the first routine comprises a routine that determines usage of air time for communication services by the subscriber via one of a cellular telephone, a pager, a personal digital assistant (PDA), a portable computer, and a laptop computer.

26. The computer program of claim 19, wherein the second routine comprises a routine that assigns a first number of points for a first communication service and a second number of points for a second communication service.

27. The computer program of claim 19, wherein the third routine comprises a routine that stores the number of points assigned to the subscriber within a database having a plurality of point accounts, one of the plurality of point accounts being associated with the subscriber.

28. The computer program of claim 19 is operable in accordance with one of a code division multiple access (CDMA) based communication protocol, a time division multiple access (TDMA) based communication protocol, and a global system for mobile communication (GSM) based communication protocol.

29. The computer program of claim 19, wherein the medium is one of paper, a programmable gate array, application specific integrated circuit, erasable programmable read only memory, read only memory, random access memory, magnetic media, and optical media.

30. A wireless communication method, the method comprising:
generating at least one point account within a first database, each of the at least one point account corresponding to a subscriber of wireless communication services;
retrieving usage of air time for wireless communication services by the subscriber from a second database, the second database being associated with a wireless communication service provider;
assigning points to the subscriber based on the usage of air time;
storing points assigned to the subscriber in the point account corresponding to the subscriber within the first database; and
rewarding the subscriber with one of a service and a product based on the points in the point account within the first database.
